(19) United States
(12) Patent Application Publication
(10) Pub. No.: US 2009/0207120 A1
(43) Pub. Date: Aug. 20, 2009

(54) METHOD FOR FAST SWITCHING INTERFACES IN LIQUID CRYSTAL DISPLAY OF PORTABLE ELECTRONIC DEVICE

(76) Inventor: Min-Pao LIN, Sinshih Township (TW)

Correspondence Address: HDLS Patent & Trademark Services, P.O. BOX 220746, CHANTILLY, VA, 20153-0746, US

(21) Appl. No.: 12/033,912

(22) Filed: Feb. 20, 2008

(51) Int. Cl. G09G 3/36

(52) U.S. Cl. 345/100

(57) ABSTRACT

A method fast switches interfaces in liquid crystal display (LCD) of portable electronic device. The registers in LCD driver apparatus are divided into first registers, which need not refreshing during interface switching, and second registers, which need refreshing during interface switching. After power on, the initial setting for LCD is carried on and power on image is display. When the interface is switched, for example from CPU interface to RGB interface, only the second registers are refreshed and the refreshing of the first registers is bypassed. The first registers are initial setting registers including power-related registers. Therefore, the refreshing of the first registers can be advantageously bypassed to save power consumption and speed up interface switch operation.

### BACKGROUND OF THE INVENTION

1. Field of the Invention

The present invention relates to a method for switching interfaces in liquid crystal display of portable electronic device, especially to a method for fast switching interfaces in liquid crystal display of portable electronic device to save power.

2. Description of Prior Art

Mobile phones have rapid progress and changes in sizes, styles and functionalities. There are 400 millions mobile phones with digital camera sold in 2005. Moreover, mobile phones with color LCD screen also become entry model for consumer. Besides, GPS service is also gradually built in mobile phones and tell the position of user when emergent event happens (the service is called E-911 in the US). For these kinds of applications, mobile phones with large TFT LCD screen are desirable for displaying larger map on mobile phones.

The conventional mobile phones use CPU interface (or referred to system interface) to link a main unit of phone and a display panel. The CPU interface is generally used for the transmission of still-image data. For example, conversation-related image can be sent from the main unit to display panel through the CPU interface.

Multimedia data interface is also provided in mobile phones as multimedia applications become popular. The multimedia data may be sent from the main unit to the display panel through an RGB interface. Through the RGB interface, signals such as VSYNC, HSYNC, DOTCLK, and data signals are sent from LCD controller to LCD driver for display. Generally, LCD driver does not have graphic memory for animated data; therefore, the RGB interface continuous sends graphic data for display and the graphic data is mostly used for animated screen. The image displayed through RGB interface is trace free because the image data is not stored in the graphic memory of the LCD driver.

FIG. 1 shows the block diagram of a prior art LCD driver apparatus. The LCD driver apparatus comprises a micro controller unit (MCU) 100, a graphic RAM (GRAM) controller 102, a graphic RAM 104, a timing controller (TCON) 106, an interface unit 108, a DC power unit 120, a one time programming (OTP) unit 122, registers 110, a source driver 160 and a gate driver 162. The interface unit 108 mainly comprises RGB interface (RGB I/F), CPU interface (CPU I/F), MIDI interface (MIDI I/F) and mobile communication processing interface (MIPI I/F). In routine operation (such as operation for conversation), the screen image data is sent to the graphic RAM (GRAM) controller 102 and the graphic RAM 104 through CPU interface in the interface unit 108, and then the source driver 160 and the gate driver 162 drives liquid crystal cell (not shown) with reference to the screen image data.

FIG. 2 shows a flowchart of interface switch procedure in LCD screen of mobile phone. After power on (S100), a default interface setting is executed (S110). Generally the default interface setting is CPU interface, the main unit of mobile phone sends the optimal initial codes to the LCD driver apparatus through SPI or I²C standard interface. Afterward, initial application setting is performed for display (S120), wherein the initial application setting includes the setting for DC level (step S120A), common voltage (VCOM) setting (S120B) and Gamma setting (S120C), which are used for setting up DC voltage level, VCOM circuit and Gamma circuit, respectively. Afterward, the main unit sends image data to the LCD panel for display (S130), which can be, for example, power on display screen.

The above mentioned steps S120A, S120B and S120C are demonstrative, and other steps are necessary for initial application setting. The detailed steps depend on the manufacturers of LCD screen. If multimedia application is involved after power on, the MCU 100 sets a specific register through interface switch signal (hardware signal) or through SPI or I²C standard interface. The display conversion setting is performed in step S140, namely, the RGB-related registers are set. The RGB-related registers can be, for example, registers for data bus latch switch, cleaning graphic RAM. Afterward, the initial application setting (S120) is performed again, and then image data is displayed (S130) after it is sent through RGB interface.

The initial application setting generally involves 80 registers and the content of the registers after interface switch are almost same. It is desirable to provide a scheme for fast switching interfaces in liquid crystal display of portable electronic devices.

### SUMMARY OF THE INVENTION

It is the object of the present invention to provide a method for fast switching interfaces in liquid crystal display of portable electronic device to save power.

Accordingly, the present invention provides a method for fast switching interfaces in liquid crystal display (LCD) of portable electronic device. The registers in LCD driver apparatus are divided into first registers, which need not refreshing during interface switching, and second registers, which need refreshing during interface switching. After power on, the initial setting for LCD is carried on and power on image is display. When the interface is switched, for example from CPU interface to RGB interface, only the second registers are refreshed and the refreshing of the first registers is bypassed. The first registers are initial setting registers including power-related registers. Therefore, the refreshing of the first registers can be advantageously bypassed to save power consumption and speed up interface switch operation.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of a prior art LCD driver apparatus.

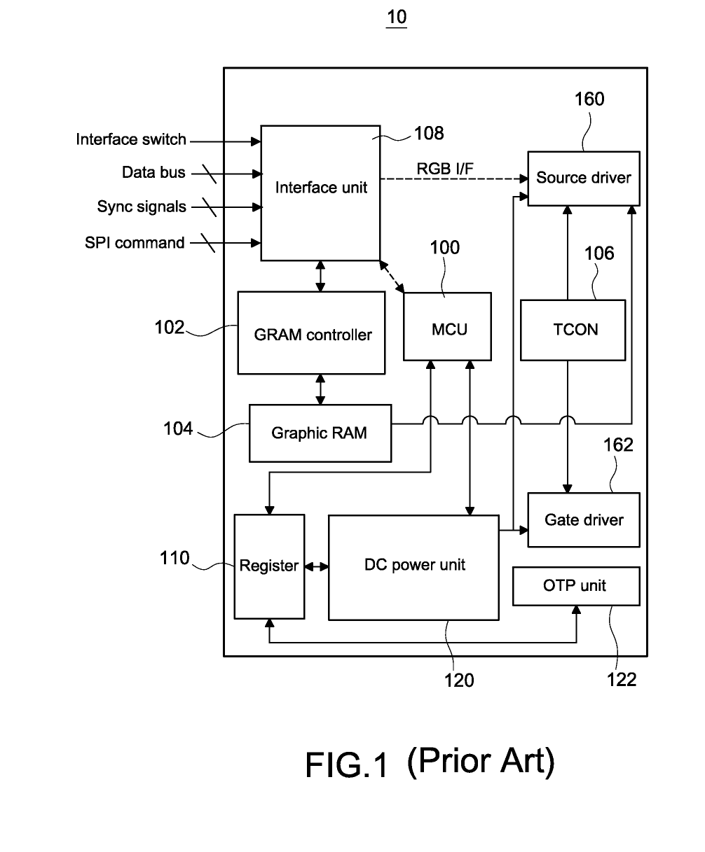

FIG. 2 shows a flowchart of prior art interface switch procedure in LCD screen of mobile phone.

FIG. 3 shows the block diagram of the LCD driver apparatus according to the present invention.

FIG. 4 shows a flowchart of interface switch procedure in LCD screen of mobile phone according to the present invention.

### DETAILED DESCRIPTION OF THE INVENTION

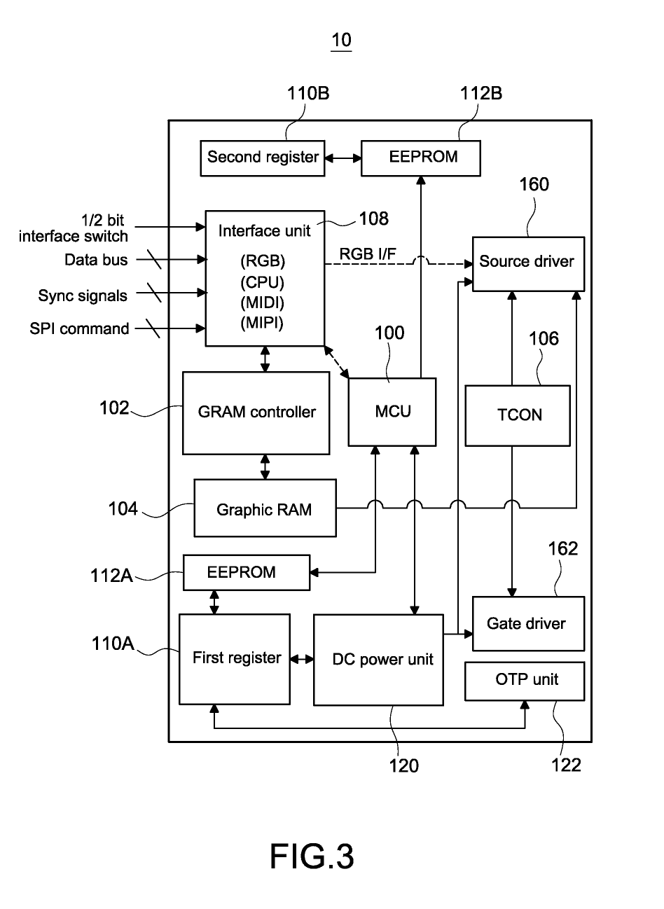

FIG. 3 shows the block diagram of the LCD driver apparatus according to the present invention. The LCD driver apparatus is similar to that in prior art and comprises a micro controller unit (MCU) 100, a graphic RAM (GRAM) controller 102, a graphic RAM 104, a timing controller (TCON) 106, an interface unit 108, a DC power unit 120, a one time programming (OTP) unit 122, first registers 110A, second registers 110B, EEPROMs 112A and 112B, a source driver 160 and a gate driver 162. The interface unit 108 mainly comprises RGB interface (RGB I/F), CPU interface (CPU I/F), MIDI interface (MIDI I/F) and mobile communication processing interface (MIPI I/F).

For clarity of explanation, the definitions of important elements are listed below.

The function of the MCU 100 is to control ON/OFF of DC powers (VDD, VGH, VGL), the voltage level of VCOM voltage, Gamma voltage and interface switch and the control of OTP.

The function of the interface unit 108 is to latch the data signal of different interfaces to facilitate the processing of the source driver 160.

The function of EEPROMs 112A and 112B is to record the register values (such as digital data for voltage levels of VDD, VGH, VGL, VCOM AC, VCOM DC, GAMMA signals) in standby mode. The data is recorded in the unit of 1 byte.

The function of the GRAM controller 102 is to control the accessing position and size of graphic memory.

Graphic RAM 104 is referred to memory for storing image data.

The first registers 110A and the second registers 110B are functional registers and used to control predetermined function through SPI command. The first registers 110A realize power-related functions such as voltage levels of VDD, VGH, VGL, VCOM AC, VCOM DC, GAMMA signals, Standby mode On/Off, and Display On/Off. The second registers 110B realize display functions such as Left/right/up/down rotation, Dithering On/Off, Partial displayer and flag for initial application setting.

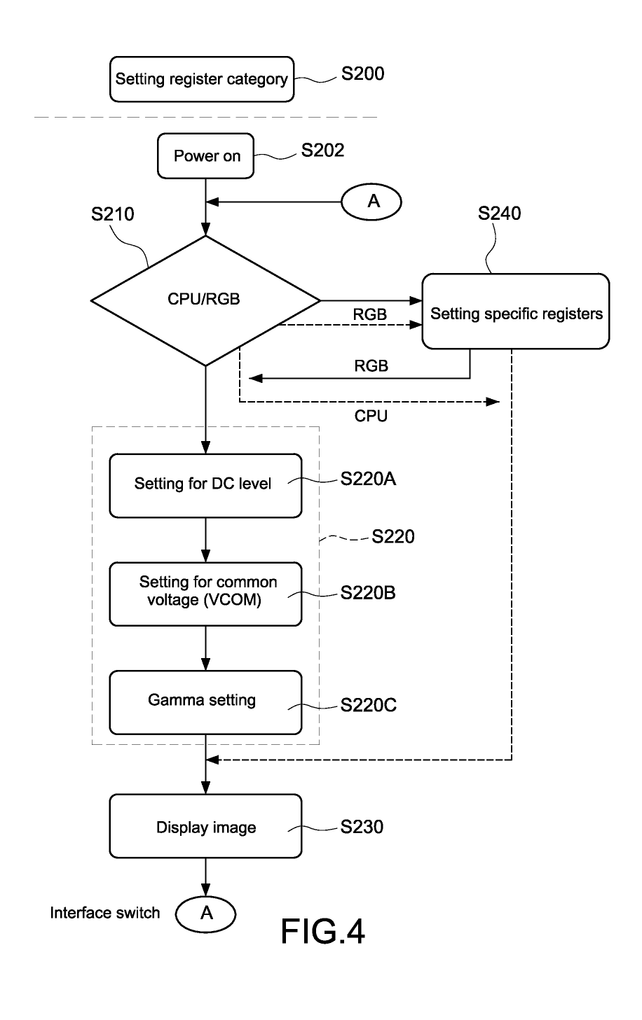

In the conventional operation for switching CPU interface to RGB interface, the content of all registers need refreshing. However, the power-related setting is not changed when LCD operation is switched from CPU interface to RGB interface. Therefore, the present invention divides the registers in LCD driver apparatus into first registers 110A, which need not refreshing during interface switch, and second registers 110B, which need refreshing during interface switch. More particularly, the first registers 110A are initial setting registers including power-related registers. Therefore, the refreshing of the first registers can be advantageously bypassed to save power consumption and speed up interface switch. The category of the registers (first registers 110A or second registers 110B) can be saved in a lookup table in the MCU 100. Moreover, the first registers 110A and the second registers 110B are drawn separately in FIG. 3 for clarity. It should be noted that the first registers 110A and the second registers 110B can be implemented integrally and are separated according to the address and function thereof FIG. 4 shows the operation flowchart of the method for fast switching interfaces in liquid crystal display of portable electronic device according to the present invention. The setting step of registers is performed before using the portable electronic device (See steps S200 separated by dashed line)

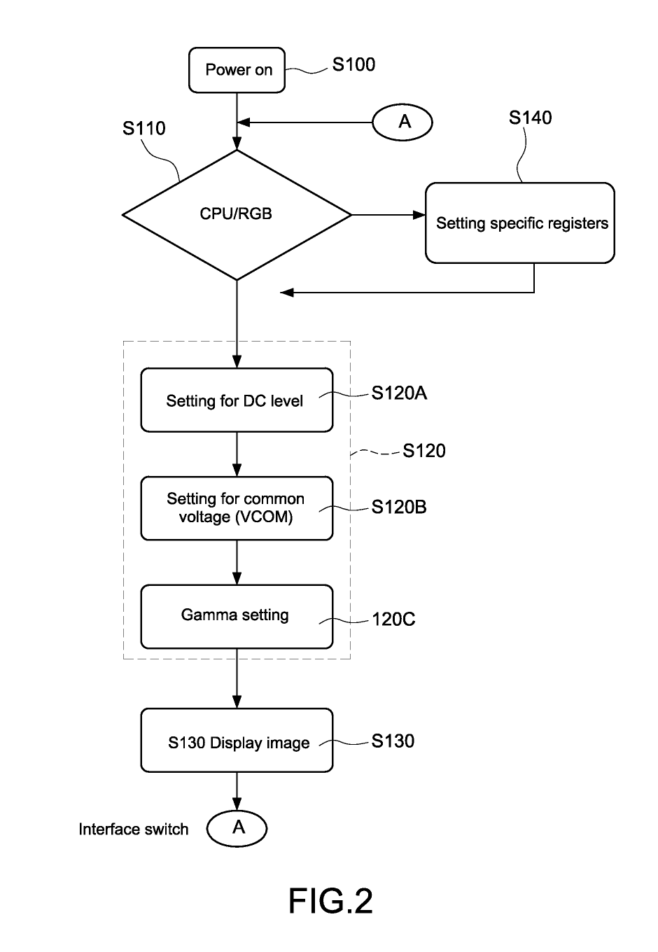

After power on (S202), the MCU 100 identifies interface switch in step S210 by an interface switch signal (hardware signal), or by a one-bit setting in a specific register set through SPI or I²C standard interface. The specific register belongs to the second registers and is similar to that described in step S140 of FIG. 2.

A power on procedure can be set in IC design phase and the MCU 100 performs initial application setting in the first registers 110A in step S220. The initial application setting includes setting for DC level, common voltage (VCOM) setting and Gamma setting, which are used for setting up DC voltage level, VCOM circuit and Gamma circuit, respectively. In the shown example, the default interface in the power on procedure is CPU interface and the main unit of mobile phone sends the optimal initial codes to the LCD driver apparatus through SPI or I²C standard interface (alternatively, the functional registers are already stored with optimal values). Therefore, the registers are stored with optimal values after step S220. Afterward, the main unit sends image data to the LCD to display, for example, power on displayed image (S230).

In the present invention, registers are discriminated in view of content change during interface switch. After the step S220 is performed, step S210 checks whether interface switch is performed (for example, from CPU interface to RGB interface). When the MCU 100 receives interface switch command from the interface unit 108, the second registers (specific registers) 110B are refreshed in step S240. Moreover, the MCU 100 does not change the content of the first registers 110A (namely bypassing step S220), and then the LCD panel directly displays image.

The dashed flow in FIG. 4 manifests the steps required for switching interface after power on. For example, if the default interface is CPU interface and then the display interface is switched to RGB interface, the second registers 110B are refreshed in step S240 and the image sent from RGB interface is displayed in step S230.

If the default interface is RGB interface, the steps are first performed through solid-line flow, wherein the second registers 110B are refreshed in step S240 and the initial application setting is performed in S220 (namely the first registers 110A are set). When the display interface is switched from RGB interface to CPU interface, the steps S240 and S220 are bypassed and the image data from the CPU interface is directly displayed in step S230.

The initial application setting performed in S220 can be a display on/off procedure in the present invention. Therefore, a one-bit flag is set in one of the first registers 110A and the second registers 110B. The one-bit flag is used to identify whether the initial application setting has been performed. The initial application setting is performed once after power on. The one-bit flag is reset after the LCD is powered off.

As can be seen from above description, the initial application setting performed in S220 can be bypassed when the interface is switched from CPU interface to RGB interface or vice versa, as long as the initial application setting has been performed once. Therefore, the interface switch operation in mobile TV application can be simplified. Animated image played back through CPU interface generally has delay problem. Moreover, power is also saved because redundant register refreshing is omitted. The method of the present invention can bypass the refreshing operation for about 40 registers. Therefore, the interface switch time can be speeded up by 1 second when refreshing time of one register (around 52 μsec) and the delay of DC power setting are taken into account. Moreover the method of the present invention can bypass the refreshing operation for about 40 registers (assuming totally 80 registers), half power consumption for refreshing the registers can be saved.

The interface unit 108 shown in FIG. 3 mainly comprises RGB interface (RGB I/F), CPU interface (CPU I/F), MIDI interface (MIDI I/F) and mobile communication processing interface (MIPI I/F). The operation shown in FIG. 4 involves interface switch between CPU interface and RGB interface. Therefore, one bit in register of the interface unit 108 can be used to record interface switch operation. The MCU 100 checks the one bit value in register of the interface unit 108 when interface is to be switched after power on. The MCU 100 can switch interface directly with reference to the one bit value in register of the interface unit 108, and the operation for setting VDD, VGH, VGL, VCOM AC, VCOM DC and GAMMA voltages can be bypassed. For switch operation involved more interfaces, for example, 4 interfaces, two-bit values in register of the interface unit 108 can be used to represent interface switch to speed up switch operation.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for fast switching interfaces in liquid crystal display of portable electronic device, the liquid crystal display comprising a driver apparatus with a CPU interface, an RGB interface and a plurality of registers, the method comprising:
dividing the plurality of registers into first registers and second registers, wherein the first registers do not need refreshing during interface change, and the second registers need refreshing during interface change;
setting CPU interface as default interface after powering on the portable electronic device, and performing an initial application setting;
displaying a power-on image;
refreshing the second registers when an operation of the liquid crystal display is switched from the CPU interface to the RGB interface; and
displaying image data sent from the RGB interface.

2. The method in claim 1, wherein the initial application setting is performed to set DC level, common voltage (VCOM) setting and Gamma setting for DC voltage level, VCOM circuit and Gamma circuit in the driver apparatus.

3. The method in claim 1, wherein the first registers are power-related registers.

4. The method in claim 1, wherein the second registers comprises registers for Left/right/up/down rotation, Dithering On/Off, Partial displayer and a flag for initial application setting.

5. The method in claim 1, further comprising:
directly displaying image sent from CPU interface when the operation of the liquid crystal display is switched from the RGB interface to the CPU interface.

6. The method in claim 1, wherein a record for dividing the registers is stored in a lookup table of the driver apparatus.

7. The method in claim 1, wherein the driver apparatus checks a one-bit record in the second registers to identify that operation of the liquid crystal display is switched from the CPU interface to the RGB interface.

8. The method in claim 1, further comprising:
setting one-bit flag in the second registers to identify whether the initial application setting has been performed.

9. A method for fast switching interfaces in liquid crystal display of portable electronic device, the liquid crystal display comprising a driver apparatus with a CPU interface, an RGB interface and a plurality of registers, the method comprising:
dividing the plurality of registers into first registers and second registers, wherein the first registers do not need refreshing during interface change, and the second registers need refreshing during interface change;
setting RGB interface as default interface after powering on the portable electronic device, and setting all of registers, wherein the initial application setting is also performed;
displaying a power-on image;
directly displaying image data sent from the CPU interface when an operation of the liquid crystal display is switched from the RGB interface to the CPU interface.

10. The method in claim 9, wherein the initial application setting is performed to set DC level, common voltage (VCOM) setting and Gamma setting for DC voltage level, VCOM circuit and Gamma circuit in the driver apparatus.

11. The method in claim 9, wherein the first registers are power-related registers.

12. The method in claim 9, wherein the second registers comprises registers for Left/right/up/down rotation, Dithering On/Off, Partial displayer and a flag for initial application setting.

13. The method in claim 9, further comprising:
refreshing the second registers when the operation of the liquid crystal display is switched from the CPU interface to the RGB interface.

14. The method in claim 9, wherein a record for dividing the registers is stored in a lookup table of the driver apparatus.

15. The method in claim 9, wherein the driver apparatus checks a one-bit record in the second registers to identify that operation of the liquid crystal display is switched from the RGB interface to the CPU interface.

16. The method in claim 9, further comprising:
setting one-bit flag in the second registers to identify whether the initial application setting has been performed.
